(19) United States
(12) Patent Application Publication
(10) Pub. No.: US 2011/0250045 A1
(43) Pub. Date: Oct. 13, 2011

(54) APPARATUS AND METHOD FOR CATCHING AND STOPPING SHINGLES PRIOR TO STACKING

(75) Inventor: David P. Aschenbeck, Newark, OH (US)

(73) Assignee: OWENS CORNING INTELLECTUAL CAPITAL, LLC, Toledo, OH (US)

(21) Appl. No.: 13/083,016

(22) Filed: Apr. 8, 2011

Related U.S. Application Data
(60) Provisional application No. 61/322,090, filed on Apr. 8, 2010.

(51) Int. Cl. B65G 47/00; B65G 57/03

(52) U.S. Cl. 414/802; 198/633; 198/617

(57) ABSTRACT

An apparatus for catching shingles includes a shingle receiving apparatus configured to receive a shingle moving at a machine speed and a deceleration assembly configured to decelerate the moving shingle upon the moving shingle's engaging the deceleration assembly.

### BACKGROUND OF THE INVENTION

Various embodiments of an apparatus and method for catching and stopping shingles prior to stacking are described herein. In particular, the embodiments described herein relate to an improved apparatus and method for catching and stopping shingles prior to stacking.

Asphalt-based roofing materials, such as roofing shingles, roll roofing and commercial roofing, are installed on the roofs of buildings to provide protection from the elements, and to give the roof an aesthetically pleasing look. Typically, the roofing material is constructed of a substrate such as a glass fiber mat or an organic felt, an asphalt coating on the substrate, and a surface layer of granules embedded in the asphalt coating.

A common method for the manufacture of asphalt shingles is the production of a continuous sheet of asphalt material followed by a shingle cutting operation which cuts the material into individual shingles. In the production of asphalt sheet material, either a glass fiber mat or an organic felt mat is passed through a coater containing hot liquid asphalt to form a tacky, asphalt-coated sheet. Subsequently, the hot asphalt-coated sheet is passed beneath one or more granule applicators which discharge protective and decorative surface granules onto portions of the asphalt sheet material to define a granule-coated sheet. The granule-coated sheet is then cooled, cut, and packaged. The cooling cutting and packaging operations are well known in the art. The cut shingles may be delivered, one at a time, at a rapid rate, such as within the range of between about 450 feet/minute (137 meters/minute) and about 1000 feet/minute (244 meters/minute) to a shingle catcher. The shingle catcher typically includes a stop member or wall into which the rapidly moving shingles collide, thus stopping the shingle. Once caught, the cut shingle may be delivered to a shingle stacker. One example of a shingle stacking machine is shown in U.S. Pat. No. 4,938, 657 issued to Benson et al., which is hereby incorporated by reference in its entirety. Another example of a shingle stacking machine is shown in U.S. Pat. No. 4,124, 128 issued to Adams et al., which is hereby incorporated by reference in its entirety.

### SUMMARY OF THE INVENTION

The present application describes various embodiments of an apparatus for catching and stopping shingles. One embodiment of the apparatus for catching shingles includes a shingle receiving apparatus configured to receive a shingle moving at a machine speed and a deceleration assembly configured to decelerate the moving shingle upon the moving shingle's engaging the deceleration assembly.

In another embodiment, a method of catching a shingle includes receiving a shingle moving at a machine speed and in a machine direction in a shingle receiving apparatus and decelerating the moving shingle to a complete stop with a deceleration assembly configured to move in the machine direction and to decelerate the moving shingle upon being engaged by the moving shingle.

In a further embodiment, a method of catching shingles includes receiving a first moving shingle of a series of moving shingles in a shingle receiving apparatus, wherein the series of moving shingles move at a machine speed and in a machine direction. The moving first shingle is decelerated to a complete stop with a deceleration assembly configured to move in the machine direction and to decelerate the moving shingle upon being engaged by the moving shingle. The stopped first shingle is moved from the deceleration assembly to a shingle stacking assembly, wherein the stacking assembly deposits the first shingle on a stacking surface. A second moving shingle of the series of moving shingles is received in the shingle receiving apparatus. The second moving shingle is decelerated to a complete stop with the deceleration assembly. The stopped second shingle is moved the from the deceleration assembly to the shingle stacking assembly, wherein the stacking assembly deposits the second shingle on the first shingle to define a stack of shingles and wherein the shingles within the stack of shingles are substantially aligned longitudinally on the stacking surface.

Other advantages of the apparatus and method for catching and stopping shingles prior to stacking will become apparent to those skilled in the art from the following detailed description, when read in light of the accompanying drawings.

### BRIEF DESCRIPTION OF THE DRAWINGS

FIG. 1 is a schematic view in elevation of a known apparatus for manufacturing an asphalt-based roofing material.

FIG. 2 is an enlarged cross-sectional schematic view in elevation of a known shingle catcher.

FIG. 3 is enlarged cross-sectional schematic view in elevation of a shingle catcher according to the invention.

FIG. 4 is an enlarged plan view partially in cross-section taken along the line 4-4 in FIG. 3.

FIG. 5 is a schematic illustration of the deceleration arm illustrated in FIG. 3.

FIG. 6 is a graph illustrating servo motor speed (rpm), current (percent of maximum current), and position of the stop plate (counts) vs. time (milliseconds).

FIG. 7 is a graph of response of the deceleration plate to plate weight.

### DETAILED DESCRIPTION OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

As used in the description of the invention and the appended claims, the term “longitudinal” or “longitudinally” is defined as substantially parallel with the machine direction.

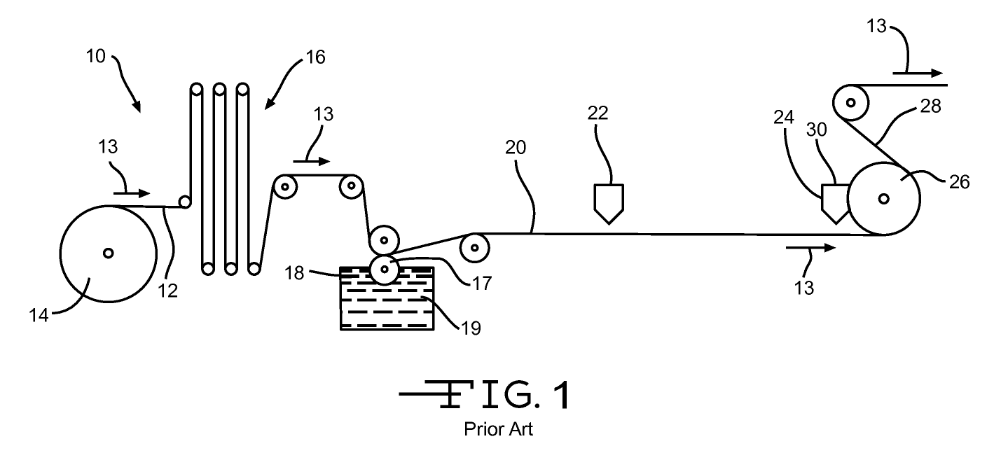

Referring now to the drawings, there is shown in FIG. 1 a known apparatus 10 for manufacturing an asphalt-based roofing material, and more particularly for applying granules onto an asphalt-coated sheet. The illustrated manufacturing process involves passing a continuous sheet of substrate or shingle mat 12 in a machine direction 13 through a series of manufacturing operations. The sheet usually moves at a speed of at least about 200 feet/minute (61 meters/minute), and typically at a speed within the range of between about 350 feet/minute (107 meters/minute) and about 1000 feet/minute (244 meters/minute). However, other speeds may be used.

In a first step of the manufacturing process, the continuous sheet of shingle mat 12 is payed out from a roll 14. The shingle mat 12 may be any type known for use in reinforcing asphalt-based roofing materials, such as a nonwoven web of glass fibers. Alternatively, the substrate may be a scrim or felt of fibrous materials such as mineral fibers, cellulose fibers, rag fibers, mixtures of mineral and synthetic fibers, or the like.

The sheet of shingle mat 12 is passed from the roll 14 through an accumulator 16. The accumulator 16 allows time for splicing one roll 14 of substrate to another, during which time the shingle mat 12 within the accumulator 16 is fed to the manufacturing process so that the splicing does not interrupt manufacturing.

Next, the shingle mat 12 is passed through a coater 18 where a coating of asphalt 19 is applied to the shingle mat 12 to form an asphalt-coated sheet 20. The asphalt coating 19 may be applied in any suitable manner. In the illustrated embodiment, the shingle mat 12 contacts a supply of hot, melted asphalt 19 to completely cover the shingle mat 12 with a tacky coating of asphalt 19. However, in other embodiments, the asphalt coating 19 could be sprayed on, rolled on, or applied to the shingle mat 12 by other means. Typically the asphalt coating is highly filled with a ground mineral filler material, amounting to at least about 60 percent by weight of the asphalt/filler combination. In one embodiment, the asphalt coating 19 is in a range from about 350° F. to about 400° F. In another embodiment, the asphalt coating 19 may be more than 400° F. or less than 350° F. The shingle mat 12 exits the coater 18 as an asphalt-coated sheet 20. The asphalt coating 19 on the asphalt-coated sheet 20 remains hot.

The asphalt-coated sheet 20 is passed beneath a first granule applicator. In the illustrated embodiment, the granule applicator is a blend drop applicator indicated generally at 22, where blend drop granules are applied to the asphalt-coated sheet 20. Although only one blend drop applicator 22 is shown, it will be understood that several blend drop applicators may be used. Also, the blend drop applicator 22 may be adapted to supply several streams of blend drops, or blend drops of different colors, shading, or size.

The asphalt-coated sheet 20 is then passed beneath a second granule applicator. In the illustrated embodiment, the granule applicator is a background granule applicator 24, for applying background granules 32 onto the asphalt-coated sheet 20. The background granules 32 adhere to the portions of the asphalt-coated sheet 20 that are not already covered by the blend drop granules. The background granules 32 are applied to the extent that the asphalt-coated sheet 20 becomes completely covered with granules, thereby defining a granule-coated sheet 28. The granule-coated sheet 28 is then turned around a slate drum 26 to press the granules into the asphalt coating and to temporarily invert the sheet 28. Such inverting of the granule-coated sheet 28 causes any excess granules 32 to drop off the granule-coated sheet 28 on the backside of the slate drum 26. The excess granules are collected by a hopper 30 of the background granule applicator 24. As described below, the hopper 30 is positioned on the backside of the slate drum 26. The granule-coated sheet 28 is then cooled, cut, stacked, and packaged.

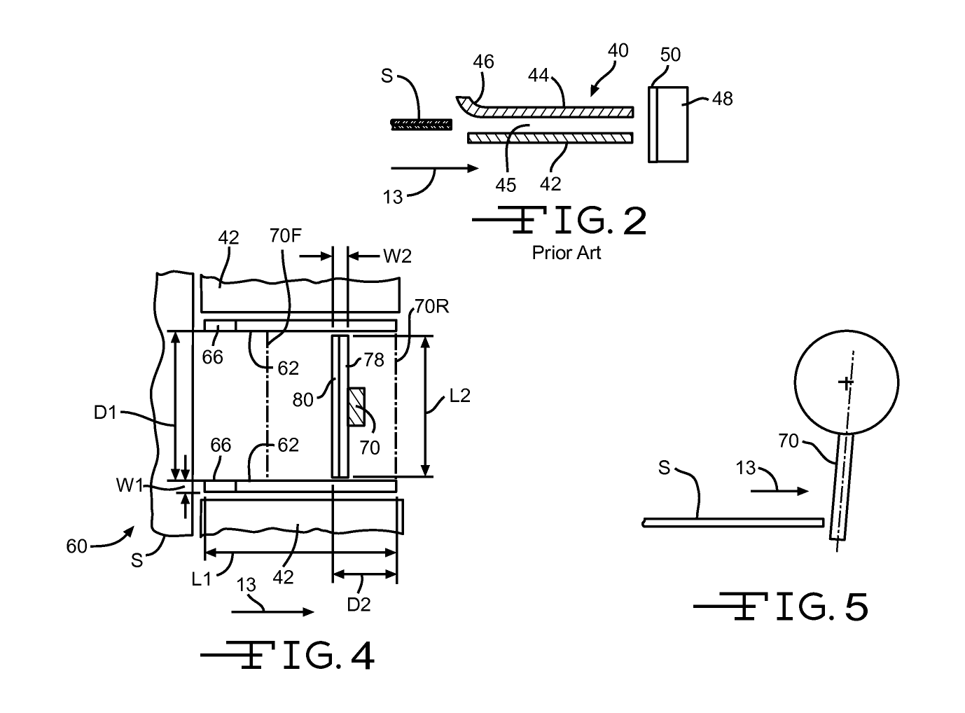

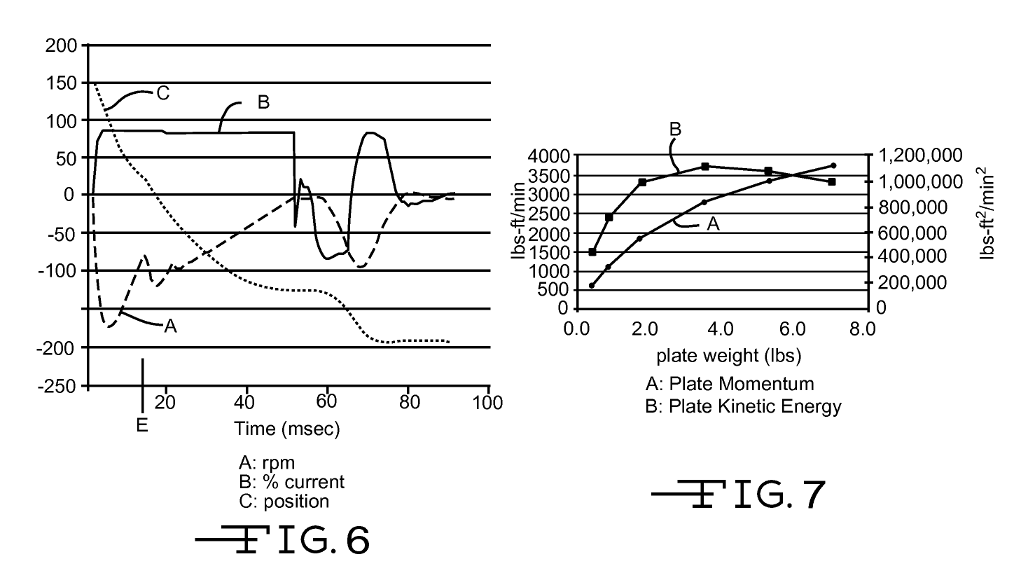

Referring now to FIG. 2, a known embodiment of a shingle catcher is shown schematically at 40. After the shingles S are cut by any desired method, the shingles S enter the shingle catcher 40 at a machine speed. The illustrated shingle catcher 40 includes the shelves or plates 42. In the illustrated embodiment, the catcher plates 42 are part of a star-wheel assembly (only the plates 42 of which are illustrated). A hold down bar 44 is mounted above the plates 42. The hold down bar 44 typically has a width within the range of from about 1.0 inches to about 5.0 inches, and includes an inclined or angled leading edge 46 which guides the shingles S moving in the machine direction 13 into the shingle receiving space 45 between the hold down bar 45 and the plates 42. The shingles S will enter the shingle receiving space 45 traveling at a machine speed, such as up to about 1000 feet/minute, and then slow slightly due to friction until the shingle S contacts a stop or wall 48. The wall 48 may be made of any suitable material such as steel, and may include a layer 50 of wear resistant material, such as a ceramic. An example of a known star-wheel assembly comprising star-wheels 32 and 33 is shown in FIGS. 6 through 8 of U.S. Pat. No. 4,124, 128.

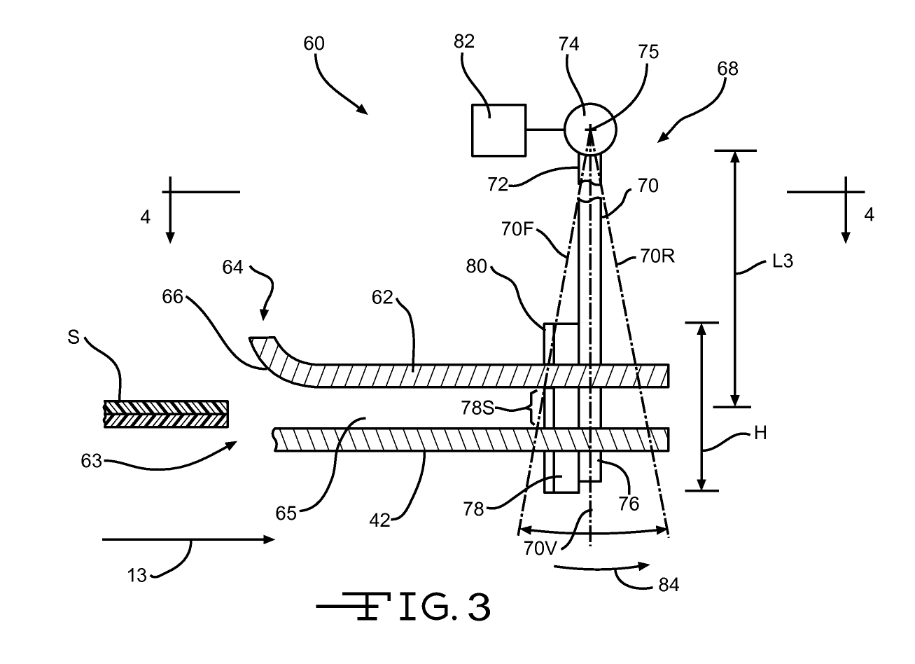

Referring now to FIGS. 3 and 4, an exemplary embodiment of the shingle catcher according to the invention is shown at 60. The shingle catcher 60 includes the plates 42 of a star-wheel assembly, as described above (only the plates 42 of which are illustrated). A pair of elongated hold down bars 62 is mounted above the plates 42. The hold down bars 62 and the plates 42 define a shingle receiving apparatus 63 for receiving a shingle moving at a machine speed, as described below. A shingle receiving space 65 is defined between the hold down bars 62 and the plates 42. The hold down bars 62 have a length L1 within the range of from about 6.0 inches to about 18.0 inches, a width W1 within the range of from about 0.25 inches to about 0.50 inches, and may be manufactured from any suitable rigid, durable material such as steel having a wear resistant coating such as ceramic or chrome. The hold down bars or bars 62 are substantially parallel to, and spaced apart from (vertically spaced apart from when viewing FIG. 3), the plates 42 a distance slightly larger than the thickness of the manufactured shingle S. Each of the pair of hold down bars 62 is also substantially parallel to and spaced apart from each other a distance D1 within the range of from about 3.0 inches to about 7.0 inches. The hold down bars 62 are spaced apart to provide a space within which the stop plate 78 of a deceleration assembly 68, described below in detail, is disposed. A first or leading edge 64 of the hold down bars 62 includes an inclined or angled portion 66 which guides the shingles S moving in the machine direction 13 into the shingle receiving space 65.

Although the hold down bars 62 are shown as a pair of elongated and substantially narrow bars or plates, it will be understood that the hold down bars 62 may have any other desired shape and configuration structured and configured to guide the shingle S into a desired position relative to the plates 42. Additionally, the hold down bars 62 may comprise a single plate or more than two plates.

The shingle catcher 60 also includes the deceleration assembly 68. The deceleration assembly 68 includes a deceleration arm 70, a first end 72 of which is rigidly attached to a motor shaft of a motor, schematically illustrated at 74. A second end 76 of the deceleration arm 70 is attached to a stop plate 78. The deceleration arm 70 may be manufactured from any suitable rigid, low weight material such as aluminum. In the illustrated embodiment, the length L3 is distance between the pivot axis 75 of the deceleration arm 70 and the portion 78S of the deceleration arm 70 or stop plate 78 where the shingles S strike the deceleration arm 70. In the illustrated embodiment, the length L3 is within the range of from about 4.0 inches to about 10.0 inches. Alternatively, the length L3 may be within the range of from about 3.0 inches to about 15.0 inches. The motor 74 may be any desired motor, such as a low inertia servo motor, which allows the arm 70 to pivot as described below.

In the illustrated embodiment, the stop plate 78 has a length L2 within the range of from about 3.0 inches to about 5.0 inches, a thickness or width W2 within the range of from about 0.25 inches to about 0.75 inches, and a height H within the range of from about 1.0 inch to about 3.0 inches. Alternatively, the length L2 may be within the range of from about 2.0 inches to about 10.0 inches, the width W2 may be within the range of from about 0.25 inches to about 1.5 inches, and the height H may be within the range of from about 0.5 inch to about 5.0 inches. The stop plate 78 may be manufactured from any suitable rigid, low weight material such as aluminum. Alternatively, the stop plate 78 may be manufactured from hardened tool steel or carbide. The stop plate 78 may also include a layer 80 of wear resistant material, such as ceramic, elastomeric material, or anodized aluminum. In the illustrated embodiment, deceleration assembly 68 is mounted such that the stop plate 78 is positioned a distance D2 within the range of from about 1.0 inches to about 3.0 inches from a desired maximum extent of travel of the shingle S, represented by the line MT. Alternatively, the distance D2 may be within the range of from about 0.5 inch to about 5.0 inches.

During operation of apparatus 10 for manufacturing an asphalt-based roofing material, the deceleration assembly 68 is positioned such that the deceleration arm 70 is not moving and further such that the moving shingle S will engage the stop plate 78 as the shingle S travels between the plates 42 and the pair of hold down bars 62. It will be understood that until engaged by the moving shingle S, the deceleration arm 70 and its attached stop plate 78 remain stationary or not moving.

The deceleration arm 70 may move between a first or forward position, indicated by the line 70F in FIG. 3, and a second or rearward position, indicated by the line 70R in FIG. 3, thereby defining a range of angular movement α. In the illustrated embodiment, the angle α is about 20 degrees, or +/− about 10 degrees from a substantially vertical position, indicated by the line 70V in FIG. 3. Alternatively, the angle α may be within the range of from about 15 degrees to about 25 degrees.

Various embodiments of a controller may be used, such as the controller schematically illustrated at 82 in FIG. 3. In a first embodiment of the controller 82, the controller is a programmable motion controller 82.

In operation, the stop plate 78 is in the forward position 70F until struck by the shingle S. Upon the stop plate 78 being struck by the shingle S moving at machine speed, the shingle S exerts a force in a first or machine direction on the stop plate 78. This causes the stop plate 78 and deceleration arm 70 to begin to rotate about its pivot axis 75; i.e., the axis of the shaft (not shown) of the servo motor 74.

The controller 82 then immediately applies a reverse current to the servo motor 74. In the illustrated embodiment, the servo motor 74 slows the movement of the deceleration arm 70, the speed of which was caused by the force of the moving shingle S. Thus, as the deceleration arm 70 begins to pivot in the direction of the arrow 84 (to the right when viewing FIG. 3), the action of the servo motor 74 on the deceleration arm 70 reduces the speed of the arm, which slows the moving shingle S immediately upon the shingle S engaging the stop plate 78.

The deceleration arm 70 continues to gradually decelerate or slow the moving shingle S as the deceleration arm 70 pivots in the direction of the arrow 84. During the deceleration of the shingle S, the reverse current applied to the servo motor 74 may be adjusted to direct or aim the stop point of the deceleration arm 70 to a desired, predetermined location or maximum extent of shingle travel, such as indicated by the line 70R, discussed below.

The deceleration arm 70 continues to pivot in the direction of the arrow 84 until a leading edge of a shingle S reaches the maximum extent of shingle travel, indicated by the line 70R in FIG. 4, where movement of the shingle S is stopped. After the deceleration arm 70 and the shingle S stop at the maximum extent of shingle travel 70R, the deceleration arm 70 again moves in the direction of the arrow 84 an additional distance of about 0.25 inches to create a space between the leading edge of the stopped shingle S and the stop plate 78, wherein the deceleration arm 70 again stops. Thus, as the plates 42 of the star-wheel assembly rotate downwardly to release the shingle S from the shingle catcher 60, there is no undesirable frictional engagement between the shingle S and the stop plate 78. After the shingle catcher 60 releases the shingle S, the deceleration arm 70 returns to its initial or forward position 70F as shown in FIG. 3. Alternatively, the arm 70 may continue to move in the direction of the arrow 84 (in a counter clockwise direction when viewing FIG. 3) until the arm 70 makes a complete revolution about the pivot axis 75 and returns to the forward position 70F.

In one embodiment of the apparatus 10, a catcher plate 42 may be positioned under the shingle catcher 60. In such an embodiment of the apparatus 10, subsequent shingles S in a series of moving shingles S also engage the deceleration assembly 68, are released by the plates 42 of the star-wheel assembly, and are stacked upon one another on a stacking surface. Advantageously, because the moving shingles are decelerated and stopped in a controlled manner before being dropped by the plates 42 of the star-wheel assembly, the shingles within the stack of shingles are substantially aligned longitudinally on the stacking surface.

It will be understood that the shingle catcher 60 disclosed herein may be used with any desired shingle stacking apparatus. For example, the shingle catcher 60 may be used with a with a shingle stacker (not shown) wherein shingles fall from the catcher 60 to a conveyor, such as a cross conveyor, which moves the shingles to a stacker at a distant location. Alternatively, the shingle catcher 60 may be used with a with a shingle stacker (not shown) wherein shingles are dropped directly from the catcher 60 into the desired shingle stacker.

In a second embodiment of the controller 82, the controller 82 is a programmable logic controller with a motion card. Alternatively, the controller 82 may include a custom programmed microprocessor, or custom firmware.

FIG. 6 is a graph illustrating the servo motor speed (rpm), current (percent of maximum current), and position of the stop plate 78 (counts) vs. time (msec). As used herein, there are 4096 counts per revolution. In the graph, the shingle S engages the stop plate 78 at time 0.0. The collision of the moving shingle S with the stationary stop plate 78 initially causes the stop plate 78 to bounce, or separate from and move ahead of the shingle S for a short distance. The reference letter E indicates the point on the curve of motor speed over time where the shingle S again engages the stop plate 78.

Advantageously, the use of a low inertia servo motor 74 and a relatively low weight arm 70 and stop plate 78 keeps the rotational inertia of the rotational system low (wherein as used herein, the rotational system is defined as the combination of the servo motor 74, the deceleration arm 70, the stop plate 78, and the associated components of each), and provides for a more gentle collision of the shingle S with the stop plate 78 and an improved ability to reduce the magnitude of the initial elastic bounce of the shingle S on the stop plate 78.

As shown in the graph in FIG. 6, when the servo motor reaches 2 to 4 rpm, the shingle S is slowed or relaxed, but not completely stopped. By decelerating the shingle S close to, but short of a complete stop, undesirable rebounding of the shingle S off of the stop plate 78 is significantly minimized or eliminated.

FIG. 7 is a graph that shows the calculated post-impact (i.e. post impact of the shingle S on the deceleration plate 78) condition of the deceleration plate 78, assuming elastic collision in a linear direction, such as the direction of the arrow 13, such as occurs when a cold shingle S strikes the deceleration plate 78. The left vertical axis is plate momentum measured in lbs-ft/min. The right vertical axis is plate kinetic energy measured in lbs-ft²/min². The horizontal axis is plate weight in pounds. In the graph shown in FIG. 7, the striking object, such as the moving shingle S, is assumed to have a weight of about 3.5 lbs. The curve A represents plate momentum at increasing plate weights. The curve B represents kinetic energy at increasing plate weights. As shown in the graph, the lower the momentum of the deceleration plate 78, the easier it is to slow the deceleration plate 78.

Although the embodiment of the deceleration assembly 68 described above includes a pivoting arm 70, it will be understood that in another embodiment, the deceleration assembly 68 may include a strike plate mounted for linear movement.

The principle and mode of operation of the apparatus and method for stopping shingles prior to stacking have been described in its preferred embodiment. However, it should be noted that the apparatus and method for stopping shingles prior to stacking described herein may be practiced otherwise than as specifically illustrated and described without departing from its scope.

What is claimed is:

1. An apparatus for catching shingles comprising:
a shingle receiving apparatus configured to receive a shingle moving at a machine speed; and
a deceleration assembly configured to decelerate the moving shingle upon the moving shingle's engaging the deceleration assembly.

2. The apparatus according to claim 1, further including decelerating the moving shingle from a machine speed to a complete stop over a distance within the range of from about 3.0 inches to about 1.0 inches.

3. The apparatus according to claim 1, wherein the deceleration assembly includes a deceleration arm having a first end attached to a motor and a second end defining an engagement surface for the moving shingle.

4. The apparatus according to claim 1, wherein the motor is a servo motor.

5. The apparatus according to claim 3, further including a controller connected to the servo motor and configured to apply a reverse current to the servo motor upon the deceleration arm being engaged by the moving shingle.

6. The apparatus according to claim 5, wherein upon engaging the deceleration arm, the moving shingle exerts a force in a first direction on the deceleration arm, and wherein the servo motor slows the movement of the deceleration arm in response to the force of the moving shingle.

7. The apparatus according to claim 1, wherein the shingle receiving apparatus includes a pair of hold down bars mounted substantially parallel and vertically spaced apart from plates of a star-wheel assembly, and wherein the pair of hold down bars and the plates of the star-wheel assembly define a shingle receiving space for receiving a shingle moving at a machine speed.

8. The apparatus according to claim 7, wherein the pair of hold down bars is substantially parallel to and spaced apart from each other.

9. The apparatus according to claim 1, wherein the stop plate of the deceleration assembly is positioned between the pair of hold down bars.

10. A method of catching a shingle comprising:
receiving a shingle moving at a machine speed and in a machine direction in a shingle receiving apparatus; and
decelerating the moving shingle to a complete stop with a deceleration assembly configured to move in the machine direction and to decelerate the moving shingle upon being engaged by the moving shingle.

11. The method according to claim 10, further including the step of stopping the moving shingle at a predetermined location.

12. The method according to claim 10, further including decelerating the moving shingle from a machine speed to a complete stop over a distance within the range of from about 3.0 inches to about 1.0 inches.

13. The method according to claim 10, wherein the deceleration assembly includes a deceleration arm having a first end attached to a servo motor and a second end, the method further including engaging the deceleration arm with the moving shingle, the moving shingle further moving the deceleration arm in the machine direction.

14. The method according to claim 13, further including applying a reverse current to the servo motor with a controller connected to the servo motor, the reverse current slowing the moving deceleration arm.

15. The method according to claim 14, further including adjusting the reverse current to direct the deceleration arm to a stop point at a predetermined maximum extent of shingle travel.

16. The method according to claim 15, wherein the deceleration arm is attached to the servo motor, and wherein upon the deceleration arm being engaged by the moving shingle, the moving shingle exerts a force in a first direction on the deceleration arm and causes the deceleration arm to move in the first direction, the method further including slowing the movement of the deceleration arm with the servo motor in response to the force of the moving shingle.

17. The method according to claim 16, further including applying torque with the servo motor to the deceleration arm in a second direction opposite the first direction.

18. The method according to claim 10, wherein the shingle receiving apparatus includes a pair of hold down bars mounted substantially parallel and vertically spaced apart from plates of a star-wheel assembly, and wherein the pair of hold down bars and the plates of the star-wheel assembly define a shingle receiving space for receiving a shingle moving at a machine speed.

19. The method according to claim 18, wherein the plates of the pair of hold down bars are substantially parallel to and spaced apart from each other.

20. A method of catching shingles comprising:
receiving a first moving shingle of a series of moving shingles in a shingle receiving apparatus, the series of moving shingles moving at a machine speed and in a machine direction;
decelerating the moving first shingle to a complete stop with a deceleration assembly configured to move in the machine direction and to decelerate the moving shingle upon being engaged by the moving shingle;
moving the stopped first shingle from the deceleration assembly to a shingle stacking assembly, the stacking assembly depositing the first shingle on a stacking surface;
receiving a second moving shingle of the series of moving shingles in the shingle receiving apparatus;
decelerating the second moving shingle to a complete stop with the deceleration assembly; and
moving the stopped second shingle from the deceleration assembly to the shingle stacking assembly, the stacking assembly depositing the second shingle on the first shingle to define a stack of shingles;
wherein the shingles within the stack of shingles are substantially aligned longitudinally on the stacking surface.
